(19) United States
(12) Patent Application Publication
(10) Pub. No.: US 2018/0290398 A1
(43) Pub. Date: Oct. 11, 2018

(54) ADDITIVE MANUFACTURING SYSTEM WITH A CHANNELED STARTER PIECE AND METHOD OF PRINTING A 3D PART UTILIZING THE STARTER PIECE

(71) Applicant: Stratasys, Inc., Eden Prairie, MN (US)

(72) Inventors: Dominic F. Mannella, Minnetonka, MN (US); William J. Swanson, St. Paul, MN (US)

(21) Appl. No.: 15/483,610

(22) Filed: Apr. 10, 2017

(51) Int. Cl. B29C 67/00; B33Y 10/00; B33Y 30/00; B33Y 50/02

(52) U.S. Cl. CPC B29C 67/0088; B29C 67/0092; B33Y 50/02; B33Y 10/00; B33Y 30/00; B29C 67/0055

(57) ABSTRACT

An additive manufacturing system for printing a 3D part includes a build platen and a starter piece supported by the build platen. The starter piece comprises a build surface having a plurality of channels and wherein the build surface has a void fraction due to an open surface area of the channels ranging from about 0.5 to about 0.95. The print head includes a nozzle configured to extrude a molten material in a print plane and wherein the extruded material is configured fill a space between the build surface and the print plane and at least partially fill a portion of the plurality of channels such that a base layer of material is printed having a substantially planar surface upon which a 3D part can be printed along a print axis.

### BACKGROUND

The present disclosure relates to 3D printers for printing or otherwise producing three-dimensional (3D) parts. In particular, the present disclosure relates to starter pieces having a channeled build surface for beginning a 3D printing process, where channels in the starter piece build surface provide a relief space for any excess material extruded onto the build surface, to thereby provide a substantially planar base layer upon which a 3D part can be printed regardless of initialnon-planarity of the starter piece.

Additive manufacturing, also called 3D printing, is generally a process in which a three-dimensional (3D) part is built by adding material to form a 3D part rather than subtracting material as in traditional machining. A typical additive manufacturing process consists of slicing a three-dimensional computer model into thin cross sections defining a series of layers, translating the result into two-dimensional position data, and feeding the data to control equipment which manufacture a three-dimensional structure in an additive build style. Additive manufacturing entails many different approaches to the method of fabrication, including fused deposition modeling, ink jetting, selective laser sintering, powder/binder jetting, electron-beam melting, electrophotographic imaging, and stereolithographic processes. Using one or more additive manufacturing techniques, a three-dimensional solid object of virtually any shape can be printed from a digital model of the object by an additive manufacturing system, commonly referred to as 3D printer.

In a fused deposition modeling additive manufacturing system, a printed part may be printed from a digital representation of the printed part in an additive build style by extruding a flowable part material along toolpaths defined according to vector position data. The part material is extruded through an extrusion nozzle carried by a print head of the system, and is deposited as a sequence of roads onto a substrate in a print plane. The extruded part material fuses to previously deposited part material, and solidifies upon a drop in temperature. In a typical system where the material is deposited in planar layers, the position of the print head relative to the substrate is incremented along a print axis (perpendicular to the print plane) after each layer is formed, and the process is then repeated to form a printed part resembling the digital representation.

In fabricating printed parts by depositing layers of a part material, supporting layers or structures are typically built underneath overhanging portions or in cavities of printed parts under construction, which are not supported by the part material itself. A support structure may be built utilizing the same deposition techniques by which the part material is deposited. A host computer generates additional geometry acting as a support structure for the overhanging or free-space segments of the printed part being formed. Support material is then deposited pursuant to the generated geometry during the printing process. The support material adheres to the part material during fabrication, and is removable from the completed printed part when the printing process is complete.

### SUMMARY

An aspect of the present disclosure relates to an additive manufacturing system for printing a 3D part includes a build platen and a starter piece supported by the build platen. The starter piece comprising a substantially flat build surface and an opposing base surface. The starter piece includes a repeating pattern of open channels that terminate at the build surface. The build surface has a void fraction ranging from about 0.5 to about 0.95. The print head includes a print nozzle configured to extrude roads of a molten material onto the starter piece while traveling along toolpaths in a print plane, wherein the print plane is nominally about a layer height above the build surface of the starter piece to form a base layer parallel to the print plane. The extruded roads in the base layer are configured fill the space between the build surface and the print plane, and wherein the channels are configured to provide a relief space for receiving any excess material extruded into the layer space, thereby providing a substantially planar surface upon which a 3D part can be printed.

Another aspect of the present disclosure relates to a starter piece for a print foundation of an additive manufacturing system that is configured to print 3D parts along a printing axis. The starter piece includes a main member having a thickness defined by a substantially flat build surface and an opposing base surface. The main member has a repeating pattern of open channels that terminate at the build surface and form a grid portion, wherein the build surface has a void fraction due to an open surface area of the channels ranging from about 0.5 to about 0.95. The main member is configured to be supported by a build platen wherein the channels terminated in the build surface are configured to receive excess molten material extending from a first layer of an extruded molten material such that the first layer adheres to the build surface when solidified and wherein a surface of the first layer of molten material is substantially planar, thereby providing a substantially planar surface upon which a 3D part can be printed.

Another aspect of the present disclosure relates to a method for printing 3D parts with an additive manufacturing system. The method includes providing a starter piece comprising a build surface spaced about a layer height distance from a print plane when mounted to a built platen, wherein a portion of the starter piece includes a plurality of channels that terminate in the build surface such that at least a portion of the starter piece has a void fraction ranging from about 0.5 to about 0.95. The method includes providing a source of material and providing a print head and a nozzle with a distal end. The nonplanarity of the starter piece relative to a print plane is determined and the distal end of the nozzle is positioned in the print plane at a location where the starter plate is closest to the print plane. The method includes feeding the material to the print head and extruding the material in a molten state such that molten material is deposited from the nozzle while the nozzle is moved along toolpaths in the print plane, wherein the molten material fills the space between the starter piece and the print plane and wherein excess molten material enters a portion of the plurality of channels, such that the printed layer has a substantially planar surface upon which a 3D part may be built. The method includes printing the 3D part in a layer by layer manner along a printing axis using the substantially planar surface of the material as a base to onto which the 3D part is printed.

### Definitions

Unless otherwise specified, the following terms as used herein have the meanings provided below:

The terms “about” and “substantially” are used herein with respect to measurable values and ranges due to expected variations known to those skilled in the art (e.g., limitations and variabilities in measurements).

Directional orientations such as “above”, “below”, “top”, “bottom”, and the like are made with reference to a direction along a printing axis of a 3D part. In the embodiments in which the printing axis is a vertical z-axis, the layer-printing direction is the upward direction along the vertical z-axis. In these embodiments, the terms “above”, “below”, “top”, “bottom”, and the like are based on the vertical z-axis. However, in embodiments in which the layers of 3D parts are printed along a different axis, such as along a horizontal x-axis or y-axis, the terms “above”, “below”, “top”, “bottom”, and the like are relative to the given axis. Furthermore, in embodiments in which the printed layers are planar, the print axis is normal to the print plane of the layers.

The term “printing onto”, such as for “printing a 3D part onto a print foundation” includes direct and indirect printings onto the print foundation. A “direct printing” involves depositing a flowable material directly onto the print foundation to form a layer that adheres to the print foundation. In comparison, an “indirect printing” involves depositing a flowable material onto intermediate layers that are directly printed onto the receiving surface. As such, printing a 3D part onto a print foundation may include (i) a situation in which the 3D part is directly printed onto to the print foundation, (ii) a situation in which the 3D part is directly printed onto intermediate layer(s) (e.g., of a support structure), where the intermediate layer(s) are directly printed onto the print foundation, and (iii) a combination of situations (i) and (ii).

The term “starter piece” refers to a monolithic or multi-component structure onto which a 3D part or a support structure is directly or indirectly printed. The starter piece includes a build surface of a wall having thickness into which the channels extend where the wall is configured to accept molten material where the surface of the starter piece can be oriented from a substantially horizontal position to a substantially vertical position and any angle therebetween. The build surface can be planar, substantially planar, or may exhibit some non-planarity.

The term “providing”, such as for “providing a chamber” and the like, when recited in the claims, is not intended to require any particular delivery or receipt of the provided item. Rather, the term “providing” is merely used to recite items that will be referred to in subsequent elements of the claim(s), for purposes of clarity and ease of readability.

The term “support structure” can include any structure that is utilized to provide structural integrity to a part being printed. The support structure can include formations that support overhanging portions of the part, internal cavities of the part, provide support along sides of the part or underneath the part such as, but not limited to, support structures with spaced apart contact with the part, which are referred to as scaffolds. The support structure can be printed from part material or a material different from the part material.

### BRIEF DESCRIPTION OF THE DRAWINGS

FIG. 1 is a top, schematic view of an additive manufacturing system of the present disclosure for printing a 3D part horizontally.

FIG. 2 is a side, schematic view of the additive manufacturing system of the present disclosure for printing a 3D part horizontally.

FIG. 3 is a schematic view of material extruded onto a build surface of a starter piece that is substantially parallel to a print plane.

FIG. 4 is a schematic view of material extruded onto a build surface of a starter piece that is non-parallel with a print plane.

FIG. 5 is an exploded view of a starter piece and foundation.

FIG. 6 is a schematic view of a base layer being printed on a starter piece.

FIG. 7 is a sectional view taken along section line 7-7 in FIG. 6.

FIG. 8 is a sectional view taken along section line 8-8 in FIG. 6.

FIG. 9 is a schematic view of a base layer being printed on another starter piece

FIG. 10 is a sectional view taken along section line 10-10 in FIG. 9.

FIG. 11 is a sectional view taken along section line 11-11 in FIG. 9.

### DETAILED DESCRIPTION

The present disclosure is directed to a starter piece that is configured to accept one or more base layers of material used to build a 3D part in a layer by layer manner with an extrusion based additive manufacturing system, commonly referred to as a 3D printer. The starter piece has a substantially flat build surface and an opposing base surface and a repeating pattern of open channels that terminate at the build surface and form a grid portion. The plurality of channels is configured to accept a pressurized flow of molten material extruded from the nozzle of an extruder or liquefier. The extruded molten material enters into the channels in the starter piece through the openings in the build surface in areas when there is an excess of molten material deposited, such as where there is a lack of planarity between the starter piece and the print plane. The extruded material seeps into the channels in those areas, thereby leveling itself and creating a smooth surface for building a 3D part. The excess molten material becomes bonded into the starter piece channels when the material solidifies, and provides a planar surface for building a part. The starter piece may or may not be reusable.

The present disclosure is also directed to a method of printing a 3D part utilizing the starter piece where the build surface is substantially flat but may exhibit non-planarity and the build surface may be substantially parallel or non-parallel relative to a print plane. The method includes determining one or more positions of the build surface by moving a distal end of a nozzle of the extruder or liquefier into contact with the starter piece to determine the location of the build surface relative to the print plane. In the case where the platen is flat but not in the same plane as the print head nozzle, the high point/low point of the platen must be determined, to establish the print plane for the first layer. In some instances, a single contact point proximate a midpoint of the build surface is sufficient to determine the location of the build surface with sufficient accuracy to print a base layer for the 3D part. In other instances, multiple contact points are utilized to determine the location of the build surface with sufficient accuracy to begin printing the base layer.

With the position of the build surface relative to the print plane determined, the distal end of the extruder or liquefier nozzle is positioned in the print plane at the highest point of the build surface, and molten material is extruded from the extruder or liquefier whereupon excess molten material enters the channels of the starter piece through the openings in the build surface in areas where the starter piece is higher with respect to the print plane, and fills the space between the print plane and the build surface in areas where the starter piece is lower with respect to the print plane. The resulting extruded layer has a substantially flat, planar upper surface that provides a base layer upon which the 3D part can be printed, independent of whether the build surface initially exhibits non-planarity and independent of whether the build surface is askew from the print plane. Because the quality of the printed 3D part is not dependent upon the starter piece having a planar surface or a surface substantially parallel to the print plane, less expensive starter pieces can be utilized to print 3D parts.

In typical additive manufacturing systems, a platen is utilized to provide a receiving surface onto which the printing process of a 3D part is started. To accurately build a 3D part in a layer by layer manner, the receiving surface of the platen, upon which the first layer(s) is directly printed, is substantially flat or planar to prevent printing errors in the 3D part, as the 3D part is being printed in a layer-by-layer manner.

In typical additive manufacturing systems, the planar receiving surface of the platen is positioned substantially parallel to the print plane to prevent printing errors due to misalignment of the platen relative to the print plane. In some instances, a thin, one-time-use build sheet is secured on the platen build surface, upon which the molten material is extruded, such as is described in U.S. Pat. No. 5,939,008. In other instances, a flat build tray is removably secured to the platen, such as is described in U.S. Pat. No. 7,127,309. However, neither the build sheet nor the build tray influences the plane accuracy of the platen.

If the receiving surface of the platen and the print plane in which the nozzle moves are non-parallel (or askew from each other), the platen will have raised portions and lowered portions relative to the print plane. Depending upon the degree of misalignment of the platen relative to the print plane, the distal end of the nozzle can potentially contact the receiving surface of the platen, or a substrate mounted to the platen or layers printed thereupon, proximate the raised portions and may be sufficiently spaced from the nozzle at other lowered locations such that the extruded material is inaccurately deposited. In some instances, contact between the nozzle and the base or receiving layer can result in the plugging of the extrusion port (due to back pressure from excess material) and/or malformed layers (due to an uneven build surface) that will result in the 3D part being printed with errors.

To ensure the platen has the substantially flat surface that is parallel to the print plane, the platen is typically constructed from metal and the surface is machined to be flat or planar. The machining required to produce a platen with a substantially flat surface can be expensive, resulting in additional and potentially unnecessary costs. Additionally, utilizing a metal platen increases the weight to be moved as the 3D part is printed, which can require larger and more expensive drive mechanisms.

The print plane can be any angle ranging from a horizontal plane to a vertical plane. When the print plane is non-horizontal, the effect of the weight of the platen can be significant, such as a substantially vertical print plane where the print axis is substantially horizontal. Where the print axis is substantially horizontal, the effect of gravity is substantially normal to the print axis and can require a stronger drive mechanism to move the starter piece and the part being printed. The effect of the weight of the platen on the required drive mechanism is typically the greatest for a vertical print plane, with the effect of gravity being normal to the print axis, and lessens as the angle between the print axis and the direction of the gravitational force lessens.

One option to minimize cost and weight, the platen can be made of a thin and more deformable material. However, utilizing a platen constructed of a thin and more deformable material can result in the receiving surface being non-planar, as well as being in a plane that is non-parallel to the print plane, and causes printing errors, as previously discussed.

The present disclosure relates to a starter piece that eliminates the need for a precisely machined receiving surface on a platen, upon which the base layer(s) of the printing process are extruded. In an exemplary, non-limiting embodiment, the starter piece can be constructed of a light-weight material, such as a thermoplastic or thermoset polymeric material. In some embodiments, the thermoplastic or thermoset polymeric material is molded into a selected configuration to minimize the expense of producing the starter piece. In another exemplary embodiment, the starter piece may be constructed of a prefabricated metal grid or grate.

In one configuration, the starter piece can be a tray that is installed and secured into a build platen of an additive manufacturing system. In another configuration, the starter piece can be configured to be self-supporting and driven by a drive mechanism or, alternatively, the starter piece can be secured attached to another member that is driven by a drive mechanism in an additive manufacturing system.

Regardless of the configuration, the starter piece can be produced at a low cost due to the materials and additive manufacturing techniques utilized. Further, because of the additive manufacturing techniques utilized to directly print the base layer(s) onto the build surface and indirectly print the intermediate layers between the starter piece and the 3D part being printed, the surface of the starter piece can be planar or can exhibit some non-planarity because the base layer(s) of extruded material forms a substantially planar surface which provides a base onto which the 3D part is printed. Being able to utilize a starter piece with a non-planar surface reduces the design requirements and the cost to produce the build surface or the platen. Optionally, due to the low cost of the starter piece, the starter piece can be used for a single printing operation and subsequently disposed of or recycled which eliminates the time intensive task of cleaning a reusable starter piece.

In Swanson et al., U.S. Patent Application No. US20140358273, a textured platen surface can be accommodated through the mapping of the topography of the surface, and instructing the print head movement to follow the topography during build of the first layer, to provide a planar first layer surface. Mapping requires a scanning means and digital modeling software. This disclosure avoids the requirement for mapping and digital modelling of a textured surface and print path. By using a build surface, regardless of planarity with respect to the build platen, the liquefier or extruder can extrude molten material in order to raise the level of low spots, while levelling out the high spots, resulting in a substantially level surface. The channels allow excess molten material to be accommodated in levels with high spots, while not being significantly utilized in low spots, due to lack of extrusion pressure of the molten material from the print head nozzle against the starter plate. In the low spots, the molten resin material may not fill the channels whatsoever, or may utilize the channels only slightly (depending on channel size and molten resin viscosity). In the high spots, the channels may be partially or entirely filled with molten resin during the travel of the print head across its surface, while minimizing the base layer height in those areas.

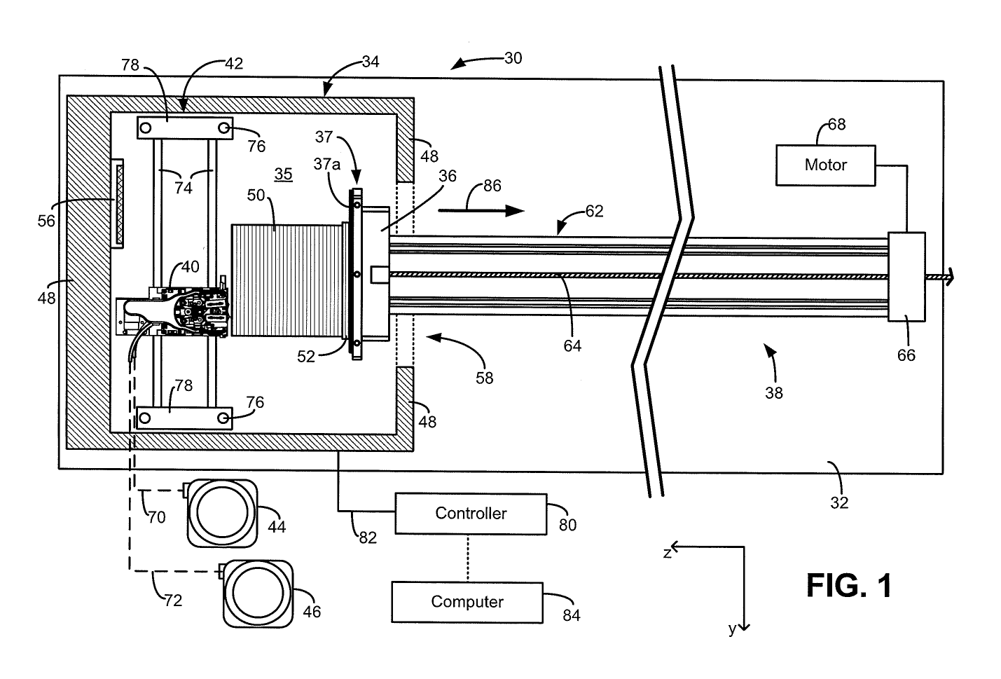

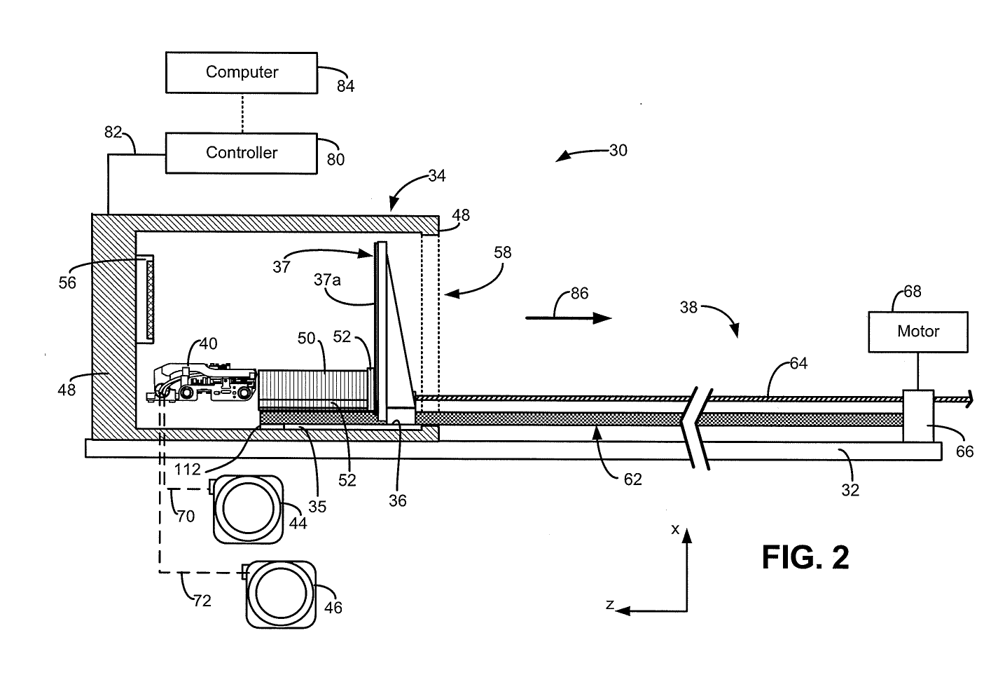

FIGS. 1 and 2 illustrate an exemplary additive manufacturing system 30 configured to print 3D parts that can be longer than a print environment of the system 30. The system 30 is configured to print the 3D parts along a substantially horizontal print axis (the z-axis) and in a substantially vertical print plane (an x-y plane), such as 3D part 50, by in part directly printing and securing initial base layer(s) 52 to a channeled build surface 37a of a starter piece 37. As mentioned above the build surface 37a of the starter piece 37 can exhibit non-planarity while being able to accurately print a 3D part in a layer-by-layer manner because of the interaction of the molten material with a distal surface of a nozzle which results in the material forming a substantially planar surface through the printing process.

As shown in FIG. 1, system 30 may rest on a table or other suitable surface 32, and can include chamber 34, mounting piece 36 carrying starter piece 37, gantry 38 configured to move mounting piece 36 and starter piece 37, print head 40 having a distal nozzle 41, head gantry 42, and consumable assemblies 44 and 46. Chamber 34 is an enclosed environment having chamber walls 48, and initially contains mounting piece 36 and starter piece 37, which are configured to accept and bond with extruded material that is utilized to print 3D parts 50 and support structures 52.

In the shown embodiment, chamber 34 includes heating mechanism 56, which may be any suitable mechanism configured to heat chamber 34, such as one or more heaters and air circulators to force heated air throughout chamber 34. Heating mechanism 56 may heat and maintain chamber 34, at least in the vicinity of print head 40, at one or more temperatures that are in a window between the solidification temperature and the creep relaxation temperature of the part material and/or the support material. This reduces the rate at which the part and support materials solidify after being extruded and deposited (e.g., to reduce distortions and curling), where the creep relaxation temperature of a material is proportional to its glass transition temperature. Examples of suitable techniques for determining the creep relaxation temperatures of the part and support materials are disclosed in Batchelder et al., U.S. Pat. No. 5,866,058.

Chamber walls 48 maybe any suitable barrier that reduces the loss of the heat from the build environment within chamber 34, and may also thermally insulate chamber 34. As shown, chamber walls 48 include port 58 that provides a passage from chamber 34 to ambient conditions outside of system 30. Accordingly, system 30 exhibits a thermal gradient at port 58, with one or more elevated temperatures within chamber 34 that drop to the ambient temperature outside of chamber 34 (e.g., room temperature, about 25° C.).

In some embodiments, system 30 may be configured to actively reduce the heat loss through port 58, such as with an air curtain, thereby improving energy conservation. Furthermore, system 30 may also include one or more permeable barriers at port 58, such as insulating curtain strips, a cloth or flexible lining, bristles, and the like, which restrict air flow out of port 58, while allowing mounting piece 36 and starter piece 37 to pass therethrough.

In alternative embodiments, chamber 34 may be omitted, and system 30 may incorporate an open heatable region without chamber walls 48. For example, heating mechanism 56 may heat the heatable region to one or more elevated temperatures, such as with hot air blowers that direct the hot air towards (or in the vicinity of) print head 40. However, in some other embodiments a chamber and/or a heat chamber may be optional such as an out of oven additive manufacturing system.

Mounting piece 36 supports the starter piece 37 with the channeled build surface 37a, where 3D part 50 and support structure 52 are printed along a substantially horizontal print axis in a layer-by-layer manner utilizing the starter piece 37 with the build surface 37a providing a print foundation. The nozzle 41 of print head 40 is moved along toolpaths in a print plane located nominally about a layer thickness above the build surface 37a of the starter piece 37, to form a base layer parallel to the print plane, on which the 3D part may then be built. As the 3D part 50 and the support structure 52 grow in length as the layers are printed, the part 50 and the support structure 52 are supported and moved by gantry 38, which includes drive mechanism configured to index or otherwise move mounting piece 36 carrying starter piece 37 along with the 3D part 50 and the support structure 52 along the printing z-axis. In some instances, gantry 38 can include guide rails 62, threaded rod 64, drive 66, and motor 68.

As illustrated in FIGS. 1 and 2, starter piece 37 is secured to mounting piece 36 such that build surface 37a is retained in a substantially vertical plane. Mounting piece 36 is slidably coupled to guide rails 62, which function as linear bearings to guide mounting piece 36 along the z-axis (referred to as the printing axis), and to limit the movement of mounting piece 36 and starter piece 37 along the z-axis (i.e., restricts mounting piece 36 and starter piece 37 from moving in the x-y plane). In some embodiments, threaded rod 64 has a first end coupled to mounting piece 36 and a second portion engaged with screw drive 66. Screw drive 66 is configured to rotate and move threaded rod 64 along with mounting piece 36 and starter piece 37 along the print axis, typically a distance that is a thickness of a layer. While a threaded rod 64 and screw drive 66 are disclosed and illustrated, other drive mechanisms are within the scope of the present disclosure.

In the shown example, print head 40 is a dual-tip extrusion head configured to receive consumable filaments or other materials from consumable assemblies 44 and 46 (e.g., via guide tubes 70 and 72) for printing 3D part 50 and support structure 52. Examples of suitable devices for print head 40 include those disclosed in Crump et al., U.S. Pat. No. 5,503,785; Swanson et al., U.S. Pat. No. 6,004,124; LaBossiere, et al., U.S. Pat. Nos. 7,384,255 and 7,604,470; Leavitt, U.S. Pat. No. 7,625,200; Batchelder et al., U.S. Pat. No. 7,896,209; and Comb et al., U.S. Pat. No. 8,153,182.

In some embodiments, print head 40 may be an auger-based viscosity pump, such as those disclosed in Batchelder et al., U.S. Pat. Nos. 5,312,224 and 5,764,521, and Skubic et al., U.S. Pat. No. 7,891,964. In additional embodiments, in which print head 40 is an interchangeable, single-nozzle print head, examples of suitable devices for each print head 40, and the connections between print head 40 and head gantry 42 include those disclosed in Swanson et al., U.S. Pat. No. 8,647,102.

Print head 40 is supported by head gantry 42, which is a gantry assembly configured to move print head 40 in (or substantially in) the x-y plane which is substantially parallel to build surface 37a of starter piece 37. For example, head gantry 42 may include y-axis rails 74, x-axis rails 76, and bearing sleeves 78. Print head 40 is slidably coupled to y-axis rails 74 to move along the horizontal y-axis (e.g., via one or more motor-driven belts and/or screws, not shown). Y-axis rails 74 are secured to bearing sleeves 78, which themselves are slidably coupled to x-axis rails 76, allowing print head 40 to also move along the vertical x-axis, or in any direction in the x-y plane (e.g., via the motor-driven belt(s), not shown). While the additive manufacturing systems discussed herein are illustrated as printing in a Cartesian coordinate system, the systems may alternatively operate in a variety of different coordinate systems. For example, head gantry 42 may move print head 40 in a polar coordinate system, providing a cylindrical coordinate system for system 30. Moreover, the exemplary system is shown and described as being in a horizontal build configuration, where the print plane is vertical, the printer can have any orientation, ranging from fully horizontal to fully vertical.

Suitable devices for consumable assemblies 44 and 46 include those disclosed in Swanson et al., U.S. Pat. No. 6,923,634; Comb et al., U.S. Pat. No. 7,122,246; Taatjes et al, U.S. Pat. Nos. 7,938,351 and 7,938,356; Swanson, U.S. Patent Application Publication No. 2010/0283172; and Mannella et al., U.S. Pat. Nos. 9,073,263 and 8,985,497.

Suitable materials and filaments for use with print head 40 include those disclosed and listed in Crump et al., U.S. Pat. No. 5,503,785; Lombardi et al., U.S. Pat. Nos. 6,070,107 and 6,228,923; Priedeman et al., U.S. Pat. No. 6,790,403; Comb et al., U.S. Pat. No. 7,122,246; Batchelder, U.S. Pat. Nos. 8,215,371, 8,221,669, 8,236,227 and 8,658,250 U.S. Patent Application Publication Nos. 2011/0117268, 2011/0121476, and 2011/0233804; and Hopkins et al., U.S. Pat. No. 8,246,888.

System 30 also includes controller 80, which is one or more control circuits configured to monitor and operate the components of system 30. For example, one or more of the control functions performed by controller 80 can be implemented in hardware, software, firmware, and the like, or a combination thereof. Controller 80 may communicate over communication line 82 with chamber 34 (e.g., heating mechanism 56), print head 40, motor 68, and various sensors, calibration devices, display devices, and/or user input devices.

In some embodiments, controller 80 may also communicate with one or more of mounting piece 36, gantry 38, head gantry 42, and any other suitable component of system 30. While illustrated as a single signal line, communication line 82 may include one or more electrical, optical, and/or wireless signals, allowing controller 80 to communicate with various components of system 30.

System 30 and/or controller 80 may also communicate with computer 84, which is one or more computer-based systems that communicates with system 30 and/or controller 80, and may be separate from system 30, or alternatively may be an internal component of system 30. Computer 84 includes computer-based hardware, such as data storage devices, processors, memory modules and the like for generating and storing tool path and related printing instructions. Computer 84 may transmit these instructions to system 30 (e.g., to controller 80) to perform printing operations.

During operation, controller 80 may direct print head 40 to selectively draw successive segments of the part and support material filaments from consumable assemblies 44 and 46 (via guide tubes 70 and 72). Print head 40 thermally melts the successive segments of the received filaments such that they become molten, flowing materials. The molten, flowing materials are then extruded and deposited from print head 40 in the x-y print plane and onto build surface 37a of starter piece 37 for printing 3D part 50 (from the part material) and support structure 52 (from the support material).

Print head 40 may initially print one or more layers of support structure 52 onto build surface 37a of the starter piece 37 to provide an interface for the subsequent printing. The solidified material within the channels of the build surface 37a maintains good adhesion such that separation of the printed layers from the starter piece is minimized and/or eliminated.

As the printed 3D part 50 and support structure 52 are printed in the layer-by-layer manner along the z-axis, mounting piece 36 and starter piece 37 are indexed, typically a distance of a layer, in the direction of arrow 86 such that mounting piece 36 and starter piece 37 moves through chamber 34 towards port 58. Port 58 desirably has dimensions that allow mounting piece 36 and starter piece 37 to pass through without contacting chamber walls 48. Port 58 has dimensions that are larger than the cross-sectional area of build surface 37a of starter piece 37, which allows starter piece 37 (and the growing 3D part 50 and support structure 52) to pass through port 58 without interference.

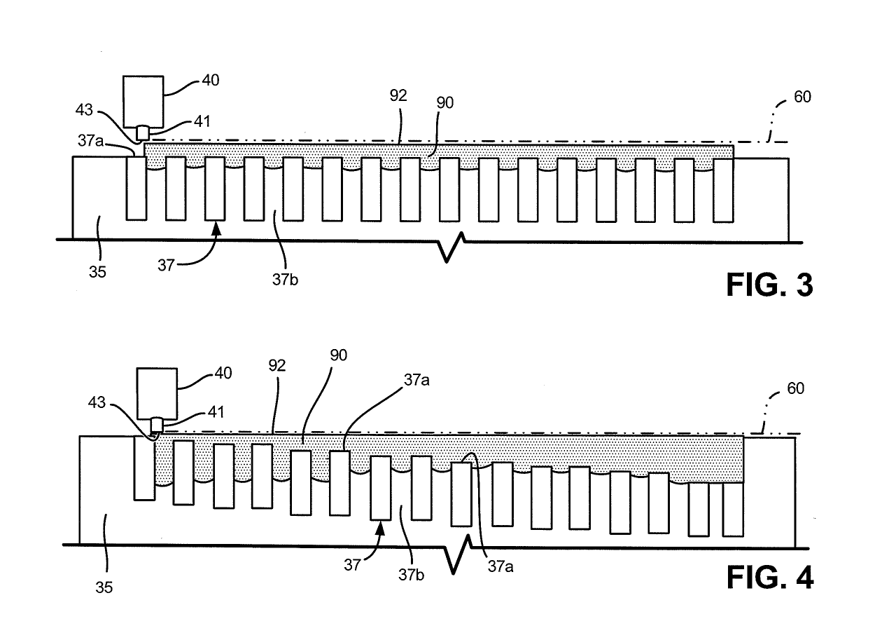

Referring to FIG. 3, the build surface 37a of the starter piece 37 is illustrated as being substantially parallel to a print plane 60 (which may be horizontal, vertical, or other orientation). The nozzle 41 of print head 40 travels along toolpaths in the print plane 60, while extruding roads of a molten material onto the build surface 37a of the starter piece 37, wherein the print plane is nominally about a layer height above the build surface 37a to form a base layer parallel to the print plane. The resulting extruded material 90 enters into channels 37b of the starter piece 37 through openings in the build surface 37a at a substantially similar amount across a length of the starter piece 37, and the extruded material 90 forms a base layer having a substantially planar surface 92 in the print plane 60.

Referring to FIG. 4, the build surface 37a of the starter piece 37 is illustrated as being non-parallel with the print plane 60. Utilizing the methods described herein, the material 90 is extruded in the print plane 60 where varying amounts of the molten material enter into the channels through the openings in the build surface 37a depending upon the distance between the print plane 60 and the starter piece 37 at various locations across the build surface 37a. At higher locations, the resulting base layer level is kept substantially even with the print plane by forcing more molten material to flow into the channels than it does in areas where the starter piece is lower. In the low areas of the starter piece, as the print head travels in the print plane 60 above it, there is little resistance against flow, because there is sufficient space between the print plane 60 and the substrate 37. Thus, molten material flows less into the channels, and results in an overall even layer level. The material 90 forms a substantially planar surface 92 in the print plane, independent of whether the build surface 37a is initially parallel or non-parallel with the print plane 60.

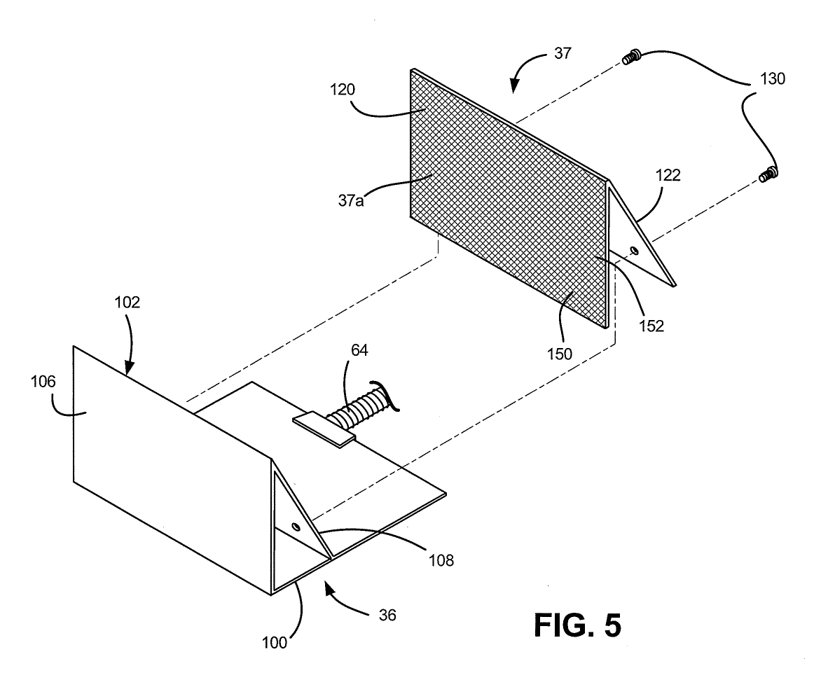

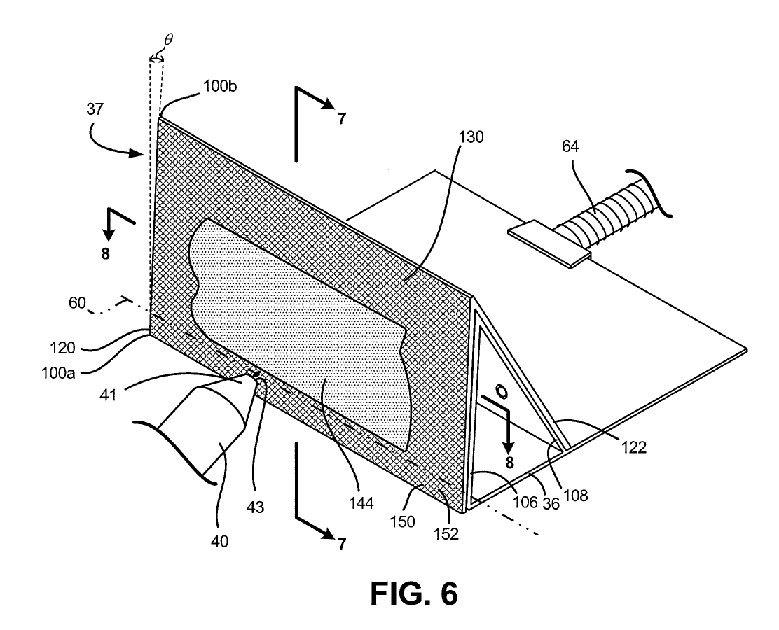

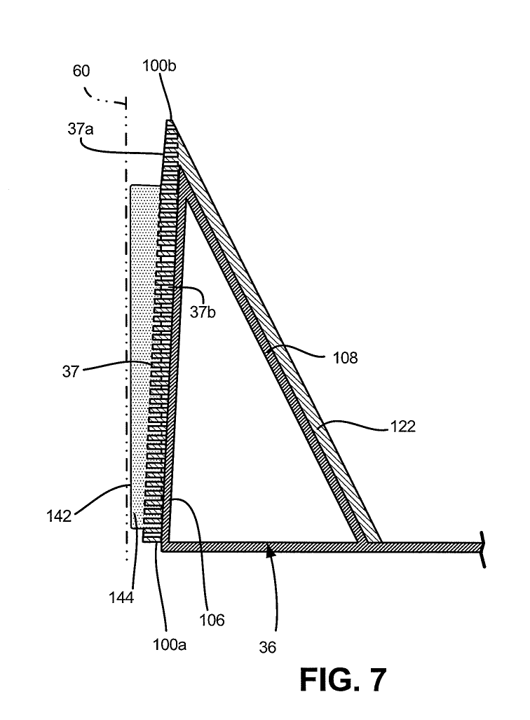

Referring to FIGS. 5-8, the starter piece 37 is configured to be removably attached to the mounting piece 36. It is also within the scope of the present disclosure for the starter piece 37 and the mounting piece 36 to be a monolithic structure.

The mounting piece 36 includes a wedge-shaped portion 102 extending upwardly from a substantially flat bottom portion 100. The wedge-shaped portion 102 includes a substantially vertical wall portion 106 that is configured to be substantially perpendicular to the bottom portion 100. An angled wall portion 108 extends from the bottom portion 100 to a top edge 110 of the substantially vertical wall portion 106. The angled wall portion 108 is configured to provide strength to the substantially vertical wall portion 106.

The mounting piece 36 typically has a monolithic construction and is configured to be reused during multiple printing operations. In order to preserve the mounting piece 36 for multiple printing operations, the starter piece 37 is removably secured to the wedge-shaped portion 102 of the mounting piece 60. The start piece 37 has a substantially vertical wall 120 having the build surface 37a. An angled wall 122 has substantially the same angle as that of angled wall portion 108 such that inner surfaces of the angled wall 122 and a portion of the substantially vertical wall 120 have a complementary configuration to that of outer surfaces of the substantially vertical wall portion 106 and the angled wall portion 108. Securing members 130 such as, by non-limiting example screws, are used to secure the angled wall 122 to the angled wall portion 108 such that a frictional engagement is created between the substantially vertical wall 120 and the substantially vertical wall portion 106 resulting in the starter piece 37 being fixedly retained to the mounting piece 60 with substantially no relative motion therebetween.

The build surface 37a of the substantially vertical wall 120 is configured to accept molten part material 144 or molten support material 144 therein. Molten part material or support material 144 is extruded into the channels 37b through openings in the build surface 37a, which increases a bonding strength between the part 50 and/or support material 52 and the starter piece 37 when the material solidifies upon a reduction in temperature. The bonding of the material 144 within the channels bonds the material to the starter piece 37, which aids in preventing undesirable separation between the starter piece 37 and the support material 52 and/or the 3D part 50 being printed. The support material 52 can either be the same material as the part material 50 or can be a different material than the part material.

As illustrated, the channels 37b of build surface 37a are defined by a first plurality of angled parallel ribs 150 and a second plurality of angled parallel ribs 152. The first plurality of angled parallel ribs 150 are positioned at about a first forty-five degree angle and the second plurality of angled parallel ribs 152 are at a second forty-five degree angle such that the first and second plurality of ribs 150 and 152 are substantially orthogonal to each other. However, other configurations of the build surface 37a are within the scope of the present disclosure.

In some embodiments, an open surface area for at least a portion of the channels ranges from about 0.0003 in.² inches to about 0.011 in.². In other embodiments, a majority of the channels are in the size range from about 0.001 in.² inches to about 0.009 in.². Yet in other embodiments substantially all of the channels have a surface area in the range from about 0.002 in.² inches to about 0.008 in.².

The channel size requirement depends on the flow rate and viscosity of the molten material; the more flowable the material, the small the diameter, because the material will more easily travel down into the channel depth. The lower limit of channel diameter size is dictated by viscosity as well—a highly viscous molten material would not flow adequately into a channel opening, and thus the layer levelling process would not occur satisfactorily. In practice, viscosity may be measured by its inverse parameter, melt flow. A desirable melt flow index for the extruded material is greater than about 1 g/10 minutes, as measured by ASTM D1238, under a load of 1.2 kg at 230° C., and is preferably between 5-10 g/10 minutes.

In some embodiments, the porosity per unit volume or void fraction is in the range of about 0.5 to about 0.95. More particularly, the porosity per unit volume or void fraction of the build surface 37a is in the range of about 0.5 to about 0.75. Even more particularly, the porosity per unit volume or void fraction is in the range of about 0.6 to 0.7.

In some embodiments, a thickness of the vertical wall 120 ranges from about 0.10 inches to about 0.5 inches. In other embodiments, the thickness of the vertical wall 120 ranges from about 0.15 inches to about 0.45 inches. In yet other embodiments, the thickness of the vertical wall ranges from about 0.20 inches to about 0.40 inches.

A depth of the channels can be the thickness of the substantially vertical wall 120, in some instances. In other instances, a back surface of the wall 120 can be sealed, such that the channels do not extend through the wall. Whatever the configuration of the substantially vertical wall 120, the channels have a sufficient depth to receive excess molten material flow, as well as ensure necessary bonding with the extruded material upon solidification, such that the part 50 and/or support structure 52 do not separate from the starter piece 37 during the printing operation.

A ratio of open area in the extrusion port of the nozzle to the cross sectional open area of a channel opening in the surface can range from about 1:1 to about 1:8 and more typically from 1:2 to about 1:6. A typical diameter of the nozzle is about 0.020 inches in diameter and the openings in the build surface 37a have an edge to edge distance of about 0.080 inches. The ratio of open area in the extrusion port of the nozzle to the cross sectional open area of a channel opening the disclosed embodiments is about 1:4.

As illustrated, the build surface 37a of the starter piece 37 does not need to be entirely planar because the method of extruding the molten material utilizing the channels of the starter piece 37 results in the extruded material forming a substantially planar surface, independent of the configuration of the build surface 37a. The build surface 37a of the starter piece 37 is also misaligned with the print plane 60 where a bottom edge 100a is closer to the print plane 60 relative to a top edge 100b such that angle θ is formed relative to a vertical plane.

The effects of a non-planar build surface 37a of the starter piece 37 and the non-parallel position of the build surface 37a relative to the print plane 60, on the accuracy of the printed 3D part 50 are minimize or eliminated by extruding a heavy bead of material 110 into a space between the build surface 37a and the print plane 60 and into the channels of the build surface 37a wherein the extrusion pressure forces the extrudate into the channels in predetermined configuration.

By way of non-limiting example, the bead can be about 0.100 inches wide and 0.010 inches and a height of a base layer is about 0.050 inches. However, the first bead can have other widths and heights and the base layer can have different heights while remaining within the scope of the present disclosure.

The build surface 37a is not required to be planar and the build surface 37a can be non-parallel to the print plane 60 because the amount of material being extruded fills the space between the print plane 60 and the build surface 37a and excess extruded material enters the channels through the openings in the build surface 37a such that the extruded materials 144 forms a base layer having a substantially planar surface 142. The channels provide a reservoir or relief space or excess material 144 which also enhances the bond between the starter piece 37 and the material 144 when the material solidifies. Depending upon the distance of the build surface 37a from the print plane 60, the distal end 43 of the nozzle 41 may contact the material 144 to aid in forming the substantially planar surface 142. However, interaction between the distal end 43 of the nozzle 41 and the extruded material 144 is not necessary to form the substantially planar surface 142.

The substantially planar surface 142 of material 144 is formed independent of whether the build surface 37a is substantially planar and/or non-parallel with the print plane 60. Therefore, a less expensive starter piece 37 can be utilized as the bonding surface for the initial layer(s) of the extruded material. Once the substantially planar surface 142 is formed, the part 50 and support material 52 can be extruded in a layer-by-layer manner until the 3D part 50 is printed, without printing errors caused by non-planarity of build surface 37a or a non-parallel surface 37a relative to the print plane.

As illustrated in FIGS. 5-8, the starter piece 37 can be utilized in an extrusion based additive manufacturing system where the print axis is substantially horizontal and the starter piece 37 is secured to the mounting piece 36 and is moved through coupling with the gantry 38. In other embodiments, a monolithic starter piece 37 is utilized that is configured to engage the gantry 38 where a separate mounting piece 36 is not required.

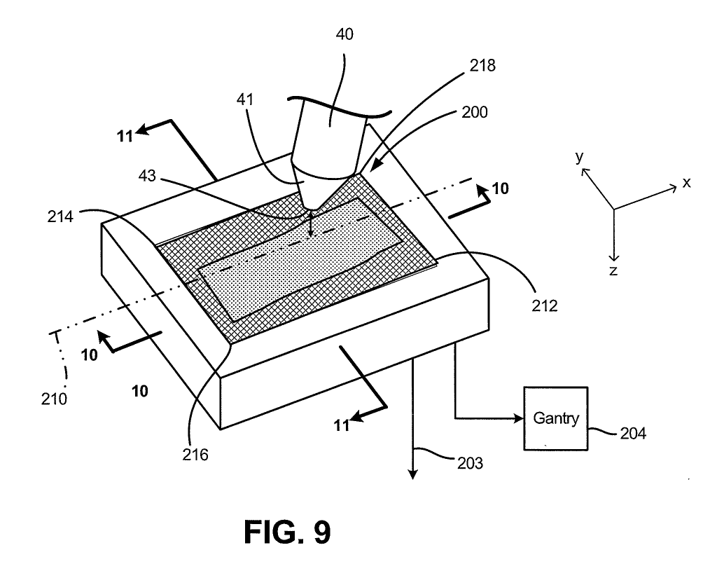

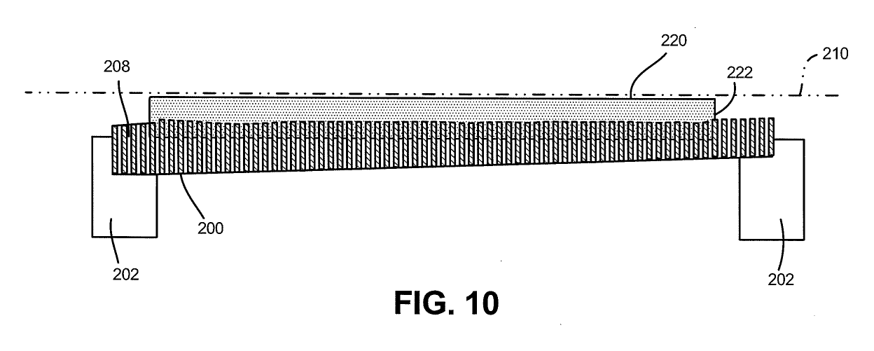

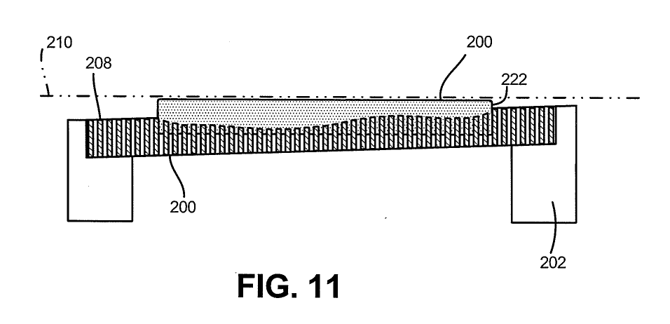

Referring to FIGS. 9-11, another embodiment of a starter piece 200 is configured as a tray that is retained to a build platen 202 where the build platen 202 moves along a substantially vertical print axis 203. An exemplary, non-limiting 3D printer with a build tray is disclosed in Dunn et al., U.S. Pat. No. 7,127,309. However, the build tray 200 can also be a component of a platen assembly configured to support a build tray, which includes support and coupling components that releasably secure the build tray to the platen during printing or build of the part, while facilitating removal of the build tray and part once completed.

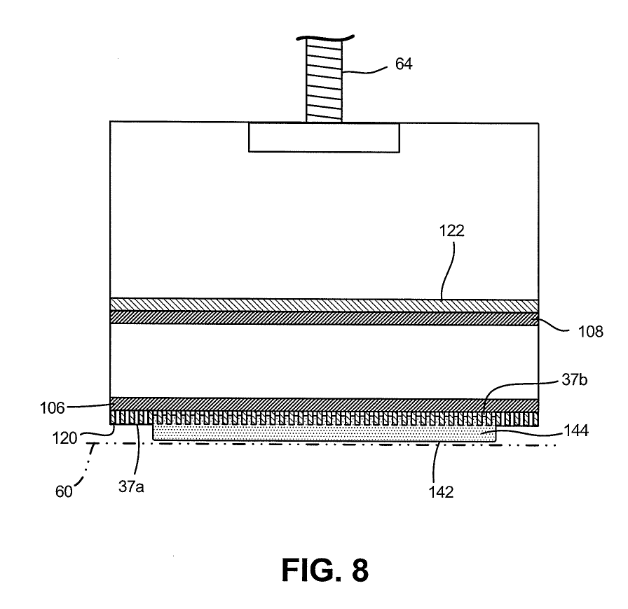

FIGS. 9-11 illustrates a print head 40 of a 3D printer having a nozzle 43 with a distal end 41 that moves in a print plane 210 where the print plane 210 is in a substantially horizontal x-y plane. The 3D printer includes a platen 202 that carries a build tray 200 where the platen 202 and the build tray 200 are moved along a substantially vertical print axis that is substantially normal to the substantially horizontal x-y print plane 210. However, the present disclosure is not limited to a 3D printer as illustrated in FIG. 8-10 having the substantially horizontal print plane 210 and a substantially vertical print axis.

As previously discussed with respect to the starter piece 37, the build tray 200 is a lightweight, polymeric or metal material that has a surface 208 that can be planar or non-planar. The surface 208 includes channels 37b having openings in the surface 208, similar to that discussed with respect to the starter piece 37, where the build tray 200 has at least a thickness as that of the substantially vertical wall 120, such that the build tray 200 can withstand the forces imparted during the printing process.

The surface 208 of the build tray 200 can be substantially parallel to the print plane 210. The surface 208 can also be non-parallel to the print plane 210 while being able to accurately print 3D parts due to the methods disclosed herein for printing the base layer(s) of materials.

By way of example, as illustrated in FIGS. 9-11, the surface 208 is misaligned from the print plane 210 where a first corner 212 is raised above the platen 202 and toward the print plane 210 and a second corner 214 is lower than an upper surface of the platen 202. Corners 216 and 218 are substantially even with the upper surface of the platen 202. As illustrated, the tray 200 is misaligned from the print plane 210 to define a space 220 having varying distances between the print plane 210 and the surface 208 of the tray 200.

As previously mentioned, the distal end 43 of the nozzle 41 of the print head 40 is positioned in the print plane 210 and extrudes a heavy bead of molten material 232 to fill the space 220 between the print plane 210 and the surface 208 where excess extruded material 232 enters into the channels of the tray 200 through the openings in the surface 208. In some instances, where the distance between the surface 208 and the print plane 210 is lessened, the distal end 43 of the nozzle 41 can engage the molten material. In other instances, where the distance between the surface 208 and the print plane is greater, the distal end 43 of the nozzle 41 will not engage the molten material.

Due to the flow of excess extruded material into the channel openings, a substantially planar surface 232 of extruded material 230 is formed independent of the position of the tray 200 relative to the print plane 210 and independent of whether the surface is or is not substantially planar. The substantially planar surface 232 provides a base upon which the 3D part 50 and support structures 52 can be printed without errors caused by a non-planar build surface 208 or misaligned build surface 208 relative to the print plane 210.

After the part is built, the starter piece is removed from the printed material and the support structure is removed from the part with known techniques such as through immersion in an aqueous bath or utilizing break away supports. The part can then be further processed with known finishing techniques to improve the part surface quality, when necessary.

Although the present disclosure has been described with reference to preferred embodiments, workers skilled in the art will recognize that changes may be made in form and detail without departing from the spirit and scope of the disclosure.

1. An additive manufacturing system for printing a 3D part by forming successive two-dimensional layers, the system comprising:
a build platen;
a starter piece configured to be removably secured to the build platen, the starter piece comprising a substantially flat build surface and an opposing base surface, and a repeating pattern of open channels that terminate at the build surface, wherein the build surface has a void fraction due to an open surface area of the channels ranging from about 0.5 to about 0.95; and
a print head having a print nozzle configured to extrude roads of a molten material onto the build surface of the starter piece while traveling along toolpaths in a print plane, wherein the print plane is nominally about a layer height above the build surface of the starter piece to form a base layer parallel to the print plane, wherein the extruded roads in the base layer are configured fill the space between the build surface and the print plane, and wherein the channels are configured to provide a relief space for receiving any excess material extruded into the layer space, thereby providing a substantially planar surface upon which a 3D part can be printed.

2. The system of claim 1, wherein the print plane is substantially horizontal.

3. The system of claim 1, wherein the print plane is substantially vertical.

4. The system of claim 1, wherein the open surface area of each single channel opening in the grid is not more than eight times as large as an open area of an extrusion port in the print nozzle.

5. The system of claim 1, wherein the cross-sectional open area of each channel ranges from about 0.0003 in.² to about 0.0.011 in.².

6. The system of claim 1, wherein a melt flow index of the material ranges from between about 5 g/10 minutes and 10 g/10 minutes under a load of 1.2 kg at 230° C.

7. The system of claim 1, wherein the build surface has a void fraction ranging from about 0.5 to about 0.75

8. The system of claim 1, wherein the build surface has a void fraction ranging from about 0.6 to about 0.7.

9. The system of claim 1 wherein a ratio of open area in an extrusion port of the print nozzle to a cross sectional open area of a channel opening in the surface can range from about 1:1 to about 1:8

10. A method for printing three-dimensional parts in successive planar layers with an additive manufacturing system, the method comprising:
providing a substantially planar build platen;
mounting to the build platen a starter piece comprising a substantially planar build surface, wherein a portion of the starter piece includes a plurality of channels that terminate in the build surface such that at least a portion of the starter piece has a void fraction ranging from about 0.5 to about 0.95, and wherein the build surface is configured to be substantially parallel to a print plane and offset from the print plane by about a layer height;
providing a source of material;
providing a print head having a nozzle with a distal end;
determining the nonplanarity of the starter piece relative to the print plane;
positioning the distal end of the nozzle in the print plane at a location where the starter plate is closest to the print plane;
feeding the material to the print head and extruding to the material in a molten state while moving the nozzle along toolpaths in the print plane, such that molten material is extruded from the nozzle onto the build surface of the starter piece, wherein the molten material fills the space between the starter piece and the print plane and wherein excess molten material enters a portion of the plurality of channels, such that a printed layer is formed having a substantially planar surface parallel to the print plane; and
printing the three-dimensional part in a layer by layer manner along a printing axis using the substantially planar surface of the printed layer as a base layer onto which the 3D part is printed.

11. The method of claim 10 and wherein the material extruded onto the build substrate is a support material.

12. The method of claim 10 and wherein the build surface is non-parallel to the print plane and wherein the extrusion of material results in the parallel, substantially planar surface of the printed layer.

13. The method of claim 10 and further comprising contacting the distal end of the nozzle with the build surface in at least one location to determine a location of the build surface relative to the print plane.

14. A starter piece for a print foundation of an additive manufacturing system for printing three-dimensional parts along a printing axis, the starter piece comprising:
a main member having a thickness defined by a substantially flat build surface and an opposing base surface, and a repeating pattern of open channels that terminate at the build surface and form a grid portion thereof, wherein the build surface has a void fraction due to an open surface area of the channels ranging from about 0.5 to about 0.95 wherein the main member is configured to be supported by a build platen wherein the channels terminating in the build surface are configured to receive excess molten material extending from a first layer of an extruded molten material, thereby providing a substantially planar surface upon which a 3D part can be printed.

15. The starter piece of claim 14, wherein the cross-sectional open area of each channel ranges from about 0.0003 in.² to about 0.0.011 in.².

16. The starter piece of claim 14, wherein the open surface area of each single channel opening in the grid is not more than eight times as large as an open area of an extrusion port in the print nozzle.

17. The starter piece of claim 14, wherein the cross-sectional open area of each channel ranges from about 0.0003 in.² to about 0.0.011 in.².

18. The starter piece of claim 14, wherein the build surface has a void fraction ranging from about 0.5 to about 0.75

19. The starter piece of claim 14, wherein the build surface has a void fraction ranging from about 0.6 to about 0.7.

20. The starter piece of claim 14 wherein the base surface is substantially closed.
